(19) United States
(12) Patent Application Publication
(10) Pub. No.: US 2007/0264459 A1
(43) Pub. Date: Nov. 15, 2007

(54) Disposable placemats which cover bottom, lip, and top surface of table

(76) Inventors: Erika L. Trujillo, Plumas Lake, CA (US); James P. Trujillo, Plumas Lake, CA (US)

Correspondence Address: Erika Trujillo, 2239 Sheridan Ranch Circle, Plumas Lake, CA, 95961, US

(21) Appl. No.: 11/433,907

(22) Filed: May 13, 2006

(51) Int. Cl. G09F 3/00; B32B 23/02

(52) U.S. Cl. 428/43; 428/194

(57) ABSTRACT

A disposable placemat which covers and adheres to the bottom (30 and 40), lip (30), and top (10) of restaurant and dining tables for small children. This placemat guards small children from what is underneath the table surfaces, thus making a sanitary environment for them. Self adhesive tape is used on the Top (60), Left side (70), right side (80), bottom (90), and top of the perforated line (100) of the backside of the placemat (50) in order to adhere to the table, keeping small children from pulling the placemat off of the dining surface. The placemat is liquid-resistant, disposable, and can be carried in a purse or diaper bag easily. Also, the placemat has a perforated tear line (20) on the bottom of the top portion of the placemat (10) in case the parent does not want the bottom portion of the placemat.

### CROSS-REFERENCE TO RELATED APPLICATIONS

NONE

### SEQUENCE LISTING OR PROGRAM

NONE

### BACKGROUND OF THE INVENTION

1. Field of Invention

This invention generally relates to placemats, specifically to partially cover the bottom of the table and which also covers and adheres to the top and lip of restaurant and dining tables for small children.

2. Prior Art

Originally placemats were made to protect only the table tops while consuming a meal. Typically, such placemats only cover the top of the table and not the bottom. This leaves the bottom of the tables totally exposed to children's hands and mouth. In eating establishments such as fast food restaurants and diners, these placemats do not cover the bottom side of the tables, which are barely ever cleaned. This exposes the children to deadly bacteria which grows under the bottom of the table. A sanitary environment is especially important for infants because of the high risk of communicable diseases. It was also noticed that children would always bite and rub their hands on the bottom of the table before they would eat. Furthermore, babies are most likely to pick gum off the bottom of the tables, not including other foreign substances. There has been nothing to address this problem. We believe that a mat that covers the top, lip, and bottom of tables are a new concept.

Accordingly, there remains a need for a placemat which covers the bottom of the tables and is less susceptible to being tampered with by children, but is disposable and inexpensive.

### OBJECTS AND ADVANTAGES

Accordingly, several objects and advantages of the invention are:
(a) to provide a placemat which uses a wipeable surface
(b) to provide a placemat which adheres to the bottom, lip and top of restaurant and dining tables with pressure sensitive adhesive strips that covers the back portion of the placemat. This keeps the child from peeling off the placemat.
(c) to provide a placemat which enables a user to divide the placemats in half, using a perforated tear line
(d) to provide a placemat which the placemat under the table protects the child from germs, communicable diseases, and other foreign substances
(e) to provide a placemat that has the bottom 2 inches folded over to create a pocket.

This benefits the parent by being a guide for their hand along the bottom of the table.

Further objects and advantages are to provide a placemat which can be used easily and conveniently to protect the child while he/she is eating, which can protect the child's hand from touching the foreign substances under the table, which is simple to use and inexpensive to manufacture, and is conveniently carried in a baby bag. Still further objects and advantages will become apparent from a consideration of the ensuing description and drawings.

### SUMMARY

This invention is a total new concept for disposable children's placemats, which is longer then the normal placemat because it covers the bottom, lip, and top of a restaurant or dining table. Children are often known to pull gum from the bottom of tables, wipe their hands across foreign substances under the table, and chew on the lip of the tables. This invention will allow the child to be less exposed to germs which are on the bottom, lip, and top of tables when dining in restaurants.

Accordingly several objects and advantages of the invention are to provide a wipeable surface, to provide a pressure sensitive adhesive strips which covers the back portion and adheres to the bottom, lip, and top of restaurant and dining tables, it keeps the child from peeling the placemat off the table, to provide a perforated tear line which enables a user to divide the placemats in half, to provide a shield so that the child does not come in contact with germs, communicable diseases, and other foreign substances, and to provide a pocket to assist the parents hand so that it does not come in contact with the bottom of the table. Still further objects and advantages will become apparent from a consideration of the ensuing description and drawings.

### DRAWINGS

### Figures

In the drawings, you will find figures that have different numbers but different reference numerals describing what is on the invention.

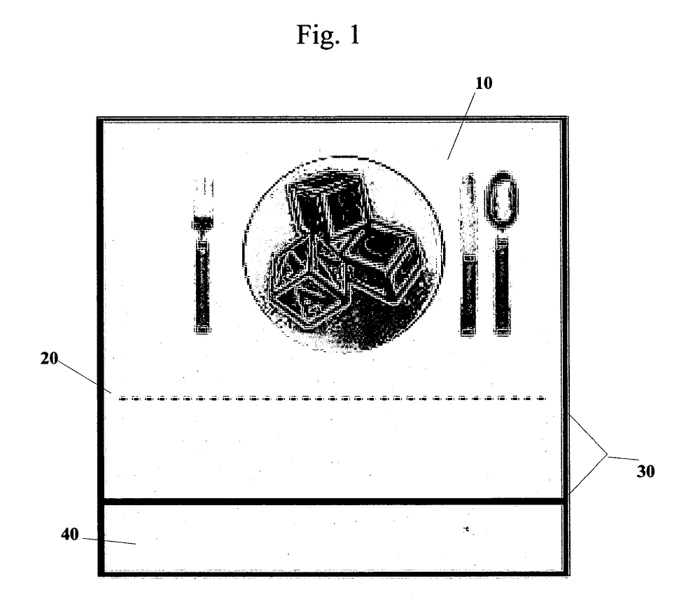

FIG. 1 shows a full bottom, lip, and front length of placemat with perforated lines, hand pocket, and possible design.

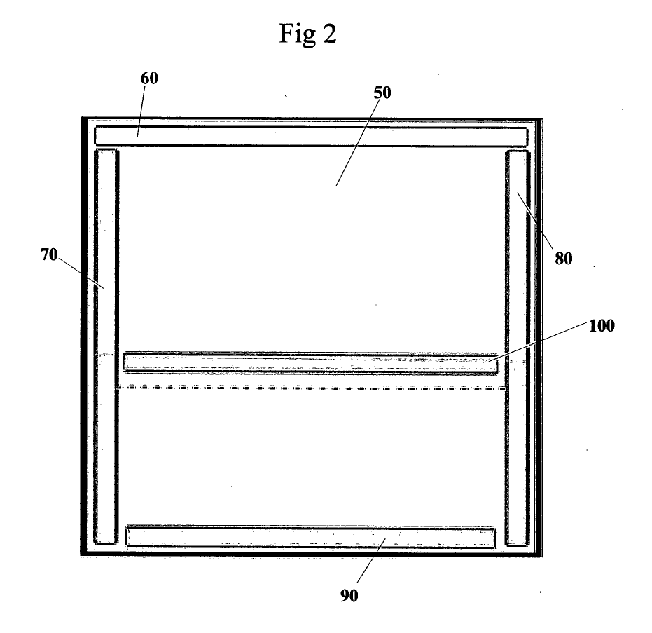

FIG. 2 shows the bottom of the placemat revealing one of the possible locations for the pressure sensitive adhesive strips strategically placed as shown on the bottom, both sides, top, and perforated line.

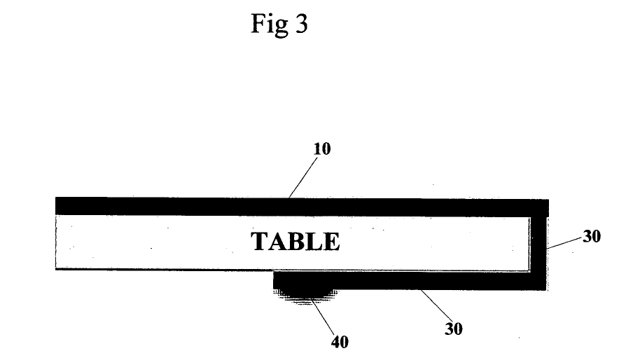

FIG. 3 shows side view of placemat which is adhered to a table.

### REFERENCE NUMERALS

10 Top of Placemat
20 Perforated Line
30 Table Lip Channel
40 Hand Pocket
50 Backside of Placemat
60 Top Self-Adhesive Tape
70 Left Side Self-Adhesive Tape
80 Right Side Self-Adhesive Tape
90 Bottom Self-Adhesive Tape
100 Top of Perforated Tear Line

### DETAILED DESCRIPTION

### FIGS. 1, 2, and 3

### Preferred Embodiment

A preferred embodiment of the child's disposable placemat is illustrated in FIG. 1 (full view of placemat and perforated tear line), FIG. 2 (full view of possible location of adhesive strips), and FIG. 3 (side view of attached placemat). However, the placemat can consist of any other material that can be repeatedly bent without breaking, such as polyethylene, polypropylene, vinyl, nylon, rubber, various impregnated or laminated fibrous materials, various plasticized materials, cardboard, paper, etc. This product will also be water resistant.

The placemat has a top 10 section that serves as a standard placemat where the child can eat. It is typically 18 inches wide and 12 inches long or could be longer in length and width. Towards the middle of the placemat there will be a perforated tear line 20 which can be torn at the 12 inch line. Approximately two inches of the table lip channel 30 will wrap around the table. This leaves approximately six to ten inches which serves as the under mat 30 and 40. Also included is a hand pocket 40 which is approximately 2 inches in width and 18 inches long. It is typically 0.5 mm to 1.0 mm in thickness, and has an overall dimensions roughly of 18 inches wide and 20 inches (rectangular shape) long or could be longer in length or width.

The backside of the placemat 50 uses a possible location for the pressure sensitive adhesive which adheres 60, 70, 80, 90 and 100 to the table. The adhesive layers of this invention can be made of any known pressure-sensitive adhesive material. As used herein, the term “pressure-sensitive” refers to any releasable adhesive or releasable tenacious means. Adhesive compositions suitable for placemats include, for example, the water-based, pressure-sensitive adhesives such as acrylate adhesives, e.g., vinyl acetate-2 ethylhexyl acetate copolymer which is generally combined with tackifiers, such as ethyleneamine. Alternatively, the adhesive may comprise a rapid setting thermoplastic “hot melt” adhesive or two-sided adhesive tape.

From the foregoing it can be realized that this invention provides a new concept of disposable placemats, for commercial use. The advantages over the prior art are covering the bottom of the tables, low cost, disposable, and increased cleanliness by curious small children.

Operation—Figs

The manner of using the children's disposable placemat is to cover the bottom 30 and 40, lip 30, and top 10 of the table, as seen in FIG. 3, while applying pressure to possible location of the pressure sensitive adhesive strips 60, 70, 80, and 90. This is to protect the children from germs, communicable diseases, and other foreign substances.

As seen in FIG. 1, the perforated tear line 20 is to be torn by the parent to enable them to just use the top 10 portion of the placemat.

As seen in FIG. 3, the table lip channel 30 covers the lip of the table and approximately 6 to 10 inches of the bottom of the table. The hand pocket 40 allows the parent to slide their hand across the bottom of the pressure adhesive strip 90 without dirtying their hand.

Once the child is done using the placemat, the parent can discard of it.

Advantages

From the descriptions above, a number of advantages of the children's disposable placemat become evident:
a) For the commercial use this product is light enough to package with 8 or more to a pack.
b) The placemat could be wiped and used again
c) The placemat adheres to the bottom, lip, and top of restaurant and dining tables.
d) The placemat has adhesive strips which cover back portion of the placemat.
e) The placemat enables the user to divide the placemat in half, using the perforated tear line.
f) The placemat protects the child from germs, communicable diseases, and other foreign substances which hide underneath the table.
g) The placemat has a hand pocket which protects the parent's hand from coming in contact with what is on the bottom of the dining table.

Accordingly, the reader will see that this disposable placemat can be used easily and conveniently to protect the child while he/she is eating and to help protect the child's hand from touching the foreign substances under the table. Furthermore, this disposable placemat has the additional advantages in that
it simplifies the use and is inexpensive to manufacture, and conveniently carried in a baby bag.
it provides a placemat which uses a wipeable surface
it provides a placemat which adheres to the bottom, lip, and top of restaurant and dining tables
it provides a secure and resealable pressure sensitive adhesive strip
it provides enough adhesive strips to keep the child from peeling off the placemat
it provides an option to use the top and bottom or just the top portion of the placemats by tearing or not tearing the perforated line
it provides protection against germs, communicable diseases, and other foreign substances
it provides an optional colorful placemat which has a printed plate, fork, knife and spoon on the top portion of the placemat.
it provides a hand pocket for the parents hand so they do not come in contact with the germ infested bottom of the table

Although the description above contains many specificites, these should not be construed as limiting the scope of the invention but as merely providing illustrations of some of the presently preferred embodiments of this invention. For example, this disposable placemat can have other shapes, such as oval, circular, triangular, etc.; the table lip channel (the under mat portion) can have other shapes; with or without perforated line; the adhesive strips could cover approximately the whole backside of the placemat; the design on the placemat can have different designs, different colors, etc.

Thus the scope of the invention should be determined by the appended claims and their legal equivalents, rather than by the examples given.

I claim:

1. A disposable placemat comprising: A sheet of cellulosic material covering the bottom, lip, and top of a table having at least four sides.

2. The placemat of claim 1 wherein said bottom, lip, and top of the placemat's surface comprises of a type of water resistant coating.

3. The placemat of claim 1 wherein the backside adheres to the bottom, lip, and top surfaces of the table with a type of pressure sensitive self adhesive tape.

4. The placemat of claim 1 wherein comprise of a perforated tear line to enable the user to use only to top portion of the placemat.

5. The placemat of claim 1 wherein the pocket helps to shield the parents hand and also help adhere the self adhesive tape to the table.

6. The placemat of claim 1 wherein the lip helps shield the child from foreign substances while biting on the lip of the table.

7. The placemat of claim 1 wherein the bottom portion is used to help protect the child from infectious bacteria.
